(19) United States
(12) Patent Application Publication
(10) Pub. No.: US 2002/0077963 A1
(43) Pub. Date: Jun. 20, 2002

(54) Artist supporting and mediating system

(76) Inventors: Kotaro Fujino, Tokyo (JP); Seiichi Kohsaka, Maebashi-shi (JP); Hidemitsu Shoyama, Tokyo (JP)

Correspondence Address: Richard C. Woodbridge, Esq., Woodbridge & Associates, P.C., P.O. Box 592, Princeton, NJ, 08542-0592, US

(21) Appl. No.: 10/016,080

(22) Filed: Dec. 12, 2001

(30) Foreign Application Priority Data
Jun. 12, 2000 (JP) 2000-176022

(51) Int. Cl. G06F 17/60

(52) U.S. Cl. 705/37

(57) ABSTRACT

The object is to provide an artist supporting and mediating system that provides opportunities for listeners, viewers and others who appreciate creative works by financially supporting unknown artists whom they favor and also provides environments for those artists to sustain creative activities with the help of those financial supports so that they can grow without the help of major sponsors until those artists become capable of sustaining their activities on their own income. It receives votes from a supporter on a preregistered artist or work by a vote accepting computer 39, charges a fee to said supporter based on a predetermined price per vote by a fee collecting computer 40, tabulates the number of votes said artist or work received by a vote tabulating computer 41, distribute support fund to said artist or work according to said number of votes received and based on a predetermined rate by a support fund distributing computer 42, and further distribute dividend to each supporter according to the number of votes cast or retained based on a predetermined condition by a dividend distributing computer 43.

### BACKGROUND OF THE INVENTION

1. Field of the Invention

The invention relates to an artist supporting and mediating system. More specifically, it is an artist supporting and mediating system that provides opportunities for listeners, viewers and others who appreciate creative works by financially supporting unknown artists whom they favor and also provides environments for those artists to sustain creative activities with the help of those financial supports so that they can grow without the help of major sponsors until those artists become capable of sustaining their activities on their own income.

2. Description of Related Art

In the field arts, including the mass entertainment field of music, literature, and painting, there are cases where sponsors of various kinds such as individuals and corporations, provide financial supports to artists, including musicians, writers and painters, until those artists become capable of sustaining their activities on their own income as professional artists. For example, music record companies in the field of music and publishing companies in the field of written arts scout for promising new faces for the purpose of profits (for non-profit purposes in some cases) and provide financial supports to unknown artists who are amateurs or semi-professionals. However, those who are lucky enough to sustain their activities throughout their unknown eras with the help of sponsors are very rare in numbers while most of those unknown artists end up being unknown for life without ever succeeding to achieve blossoming of their gifts due to lack of funds to sustain their creative activities during those trying periods.

On the other hand, listeners, viewers and art lovers have very little chance to be exposed to those unknown artists; even if they come to love and favor those unknown artists or their works accidentally, there is little means for them to continue to support those unknown artists financially. Moreover, listeners, viewers and art lovers who assist those artists wish to have a certain mechanism through which they can expect some dividends for the investment they made up to the point when those artists they have assisted succeed professionally, despite the fact that their financial supports to the artists are autonomous acts.

### SUMMARY OF THE INVENTION

The present invention is made in consideration of the abovementioned problems of the prior art and one of its intentions is to provide an artist supporting and mediating system that provides opportunities for listeners, viewers and others who appreciate creative works by financially supporting unknown artists whom they favor and also provides environments for those artists to sustain creative activities with the help of those financial supports so that they can grow without the help of major sponsors until those artists become capable of sustaining their activities on their own income.

Another intention of the present invention is to provide an artist supporting and mediating system that is capable of offering a certain mechanism through which they can expect some dividends for the investment they made up to the point when those artists they have assisted succeed professionally, despite the fact that their financial supports to the artists are autonomous acts.

Said problems can be solved by the artist supporting and mediating system of the present inventions.

The invention is an artist supporting and mediating system comprising:

a vote accepting computer that accepts votes from supporters of preregistered artists or their artistic works;

a fee collecting computer that handles a process of charging fees to said supporters according to numbers of votes cast and a predetermined unit fee per vote; a vote tabulating computer that tabulates votes for each artist or artistic work; and

a support fund distributing computer that distributes support funds to said artist or an artist who produced said artistic work corresponding to said number of votes based on a predetermined rate.

The present invention is also an artist supporting and mediating system further comprising a dividend distributing computer that distributes dividends to each supporter according to the number of votes cast by said supporter or the number of votes owned by said supporter based on a predetermined condition.

The present invention is also an artist supporting and mediating system wherein said dividend distributing computer distributes dividends when profits generated by artistic activities of said artist match with a predetermined condition.

The present invention is also an artist supporting and mediating system further comprising a vote trade mediating computer that mediates trades of votes owned by said supporters.

The present invention is also an artist supporting and mediating system further comprising a audio/visual distributing service computer that provides a service of audio/visual distribution of artistic works of preregistered artists to said supporters.

The present invention is also an artist supporting and mediating system further comprising a browsing/searching service computer that provides a service of allowing said supporters to browsing and/or searching attributive data of preregistered artists.

The present invention is also an artist supporting and mediating system comprising supporters' terminals and each said computers, which are interconnected via a computer network.

The present invention is also an artist supporting and mediating system comprising artists' terminals and each said computers, which are interconnected via a computer network.

### BRIEF DESCRIPTION OF THE DRAWINGS

FIG. 1 is a system constitution diagram showing a preferred embodiment of an artist supporting and mediating system according to the present invention.

FIG. 2 is a system constitution diagram showing a preferred embodiment of artist supporting and mediating Website of the artist supporting and mediating system according to the present invention.

FIG. 3 is a flow chart showing how artist supporting and mediating services are provided by said artist supporting and mediating Website of the artist supporting and mediating system according to the present invention.

FIG. 4 is a flow chart showing how artist/work entry services are provided by server 34 at an artist/work entry service site of the artist supporting and mediating system according to the present invention.

FIG. 5 is a flowchart showing how browsing/searching services are provided by server 37 at a browsing/searching service site of the artist supporting and mediating system according to the present invention.

FIG. 6 is a flow chart showing how audio/visual distributing services are provided by server 38 at an audio/visual distribution site of the artist supporting and mediating system according to the present invention.

FIG. 7 is a flow chart showing how voting services are provided by server 39 at a voting service site of the artist supporting and mediating system according to the present invention.

FIG. 8 is a flow chart showing the process of voting and various after services, which are characteristic portions of the artist supporting and mediating system according to the present invention.

FIG. 9 is a flow chart showing how vote trading mediation services are provided by server 45 at a vote trading mediation site of the artist supporting and mediating system according to the present invention.

### DESCRIPTION OF THE PREFERRED EMBODIMENTS

The artist supporting and mediating system according to the present invention will be described in detail with reference to the accompanying drawings.

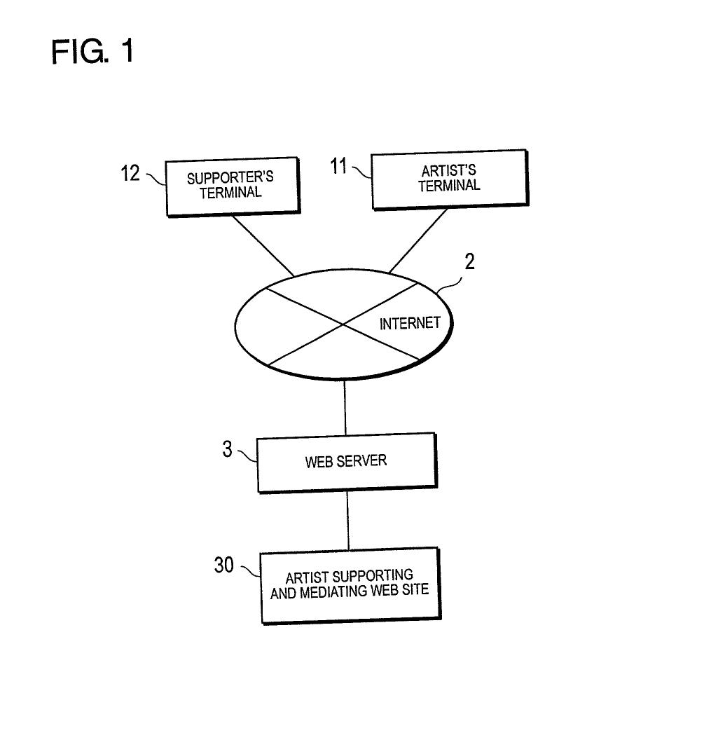

FIG. 1 is a system constitution diagram showing a preferred embodiment of an artist supporting and mediating system according to the present invention. The artist supporting and mediating system of this embodiment is intended to provide services to mediate artists and people who want to support the artists on Websites through the Internet. In the artist supporting and mediating system of this embodiment, an artist terminal 11 and a supporter terminal 12 are interconnected with an artist supporting and mediating Web server 3 via the Internet 2.

The artist or the supporter accesses the Web server 3 via the Internet 2 from their own terminals 11 or 12, such as a personal computer, handheld PC, PDA, cellular phone, etc. The artists mentioned herein are unknown artists, artists with no specific sponsors, Indies artists, regardless of whether they are amateurs or semiprofessionals, who are involved in creative works in the literary, scientific, fine arts, or music fields, including performers of classic music, jazz, pops, rocks, etc., lyricists, composers, singers, painters, illustrators, photographers, cartoonists, animation creators, directors, producers and actors/actresses of movies and theatrical plays, game writers, novelists, net writers, etc. The supporters mentioned herein are general viewers, listeners, fans, or those who support or favor a particular artist or his/her works, and who wish to support an artist or his/her works through the artist supporting and mediating system according to the present invention. The works mentioned herein are the results of artistic activities of artists, a concept that includes musical pieces played by players, songs sung by singers, and plays directed by directors or played by actors/actresses. The artistic activities mentioned herein include all activities encompassing creative works and presentations by artists, advertisements, popularization, and sales.

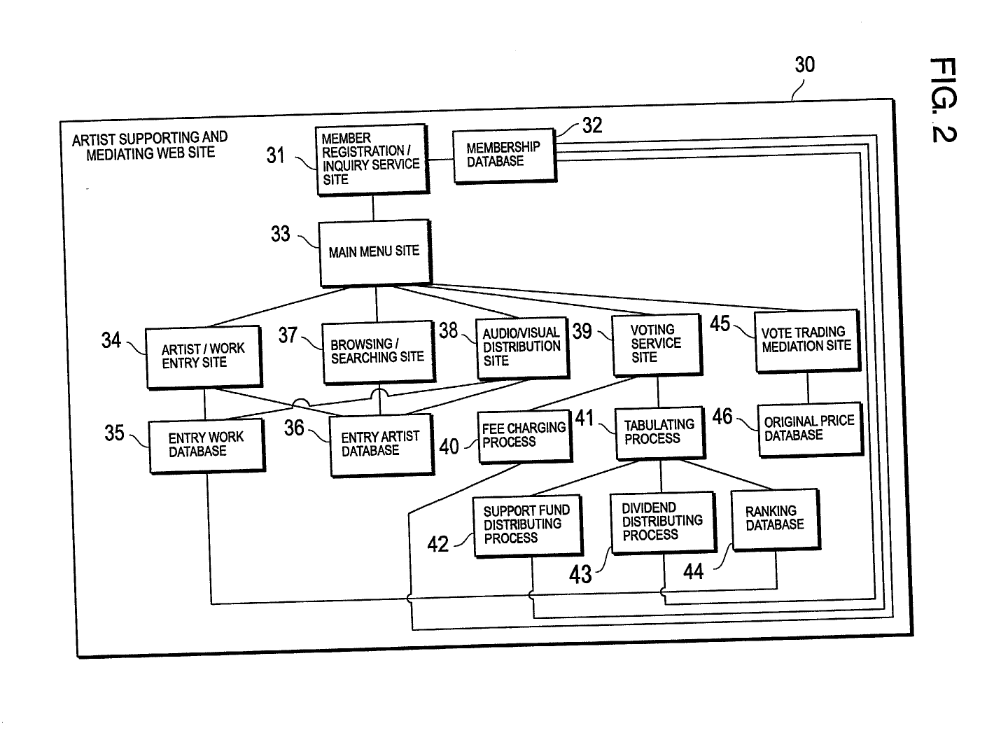

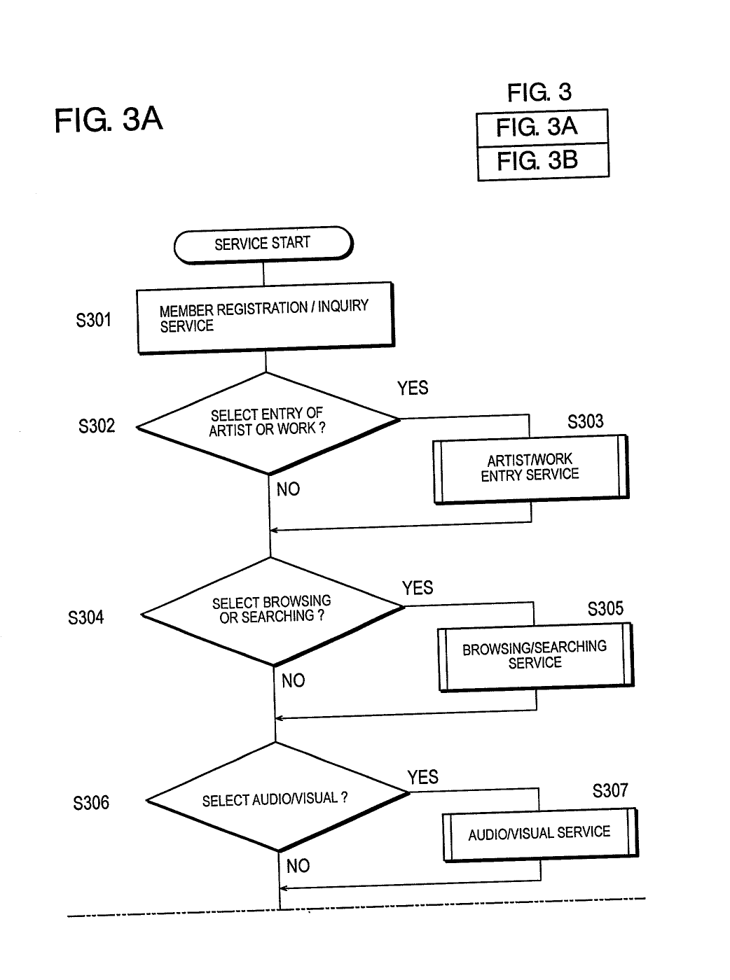

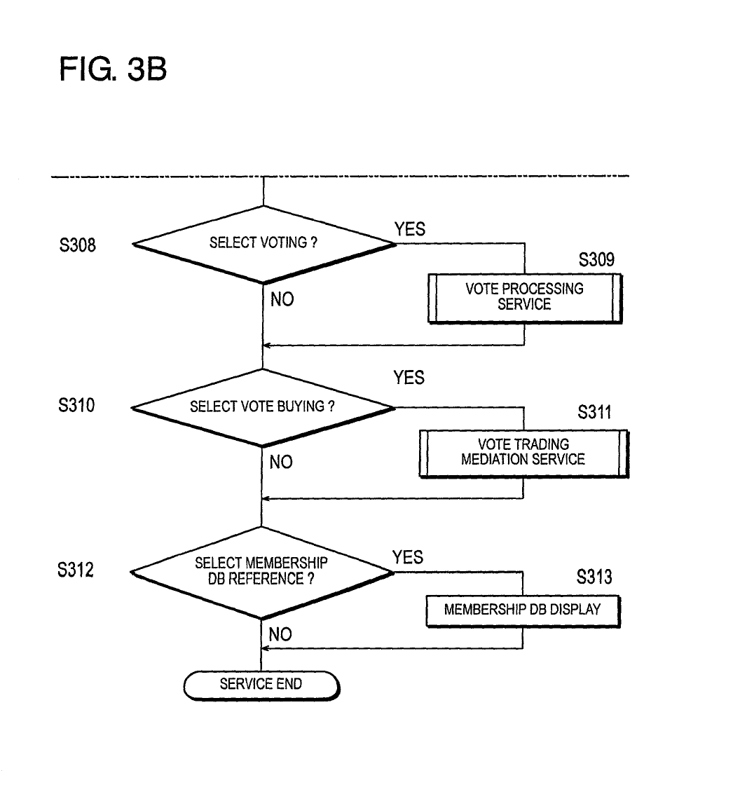

FIG. 2 is a system constitution diagram showing a preferred embodiment of artist supporting and mediating Website 30 supported by the Web server 3, where 31 through 46 are constituent servers. FIG. 3 is a flowchart showing how artist supporting and mediating services are provided by said artist supporting and mediating Website 30 of the artist supporting and mediating system according to the present invention. Steps S302, S304, S306, S308, S310 and S312 in FIG. 3 can be processed in an arbitrary order.

Any person accessing the Website 30 will be provided with member registration and reference services at the member registration/inquiry service site consisting of a server 31 (S301). More precisely, an artist or a supporter becomes eligible to use the service when he/she is registered as a member, which means that a person newly registering should enter information required for registration such as name, age, sex, address, occupation, credit card information, etc., and will be registered in the membership database consisting of a server 32 as a member once the information is certified through inquiring of the credit card information, etc. If an accessing person is preregistered member, the person will be asked to enter the account number, identification number, password, etc., upon which the entered data is queried against its membership database.

Once the accessing member is approved for connection through the membership registration and inquiry service, the main menu will be displayed on the main menu site consisting of a server 33 for the accessing member to choose a desired service (S302, S304, S306, S308, S310 and S312). The main menu includes “Artist Entry or Work Entry,” “Browsing/Searching,” “Audio/Visual,” “Voting,” “Vote Trading” “Membership Database Reference,” etc.

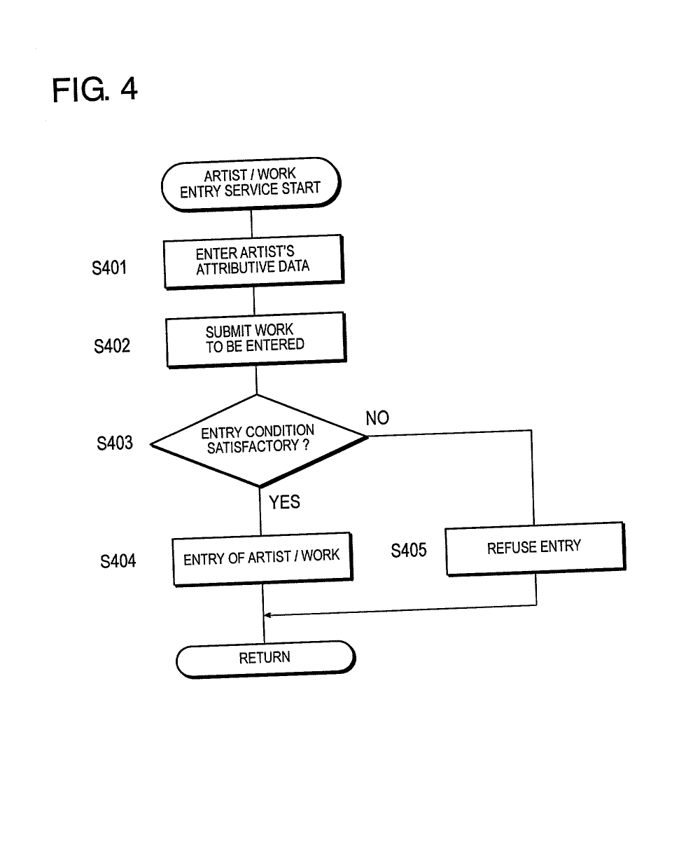

The “Artist Entry or Work Entry” menu provides a service of registering as an artist if an accessing person is an artist at the artist/work entry site consisting of a server 34, or registering a work of a preregistered artist. FIG. 4 is a flow chart showing how artist/work entry services are provided by server 34 at the artist/work entry service site. At the artist/work entry service site, the system asks an artist to enter artist attributive data such as profiles, etc. (S401) and upload an entry work at the same time (S402), examines if the entered data satisfies the entry condition (S403), and registers the person as an artist on the entry artist database consisting of a server 36 if the entered data satisfies the entry condition as well as the entry work on the entry work database consisting of a server 35 (S404). If the entered data did not meet the entry condition, said person's registration request will be denied (S405). If the accessing person is a preregistered artist, the system allows entering a work and registers it in the entry work database. In the artist support and mediating service according to the present invention, the entry of an artist or a work does not necessarily have to be made online through a network such as the Internet, but can also be made by an appropriate offline method such as postal service, courier service, facsimile, telephone, and face-to-face delivery.

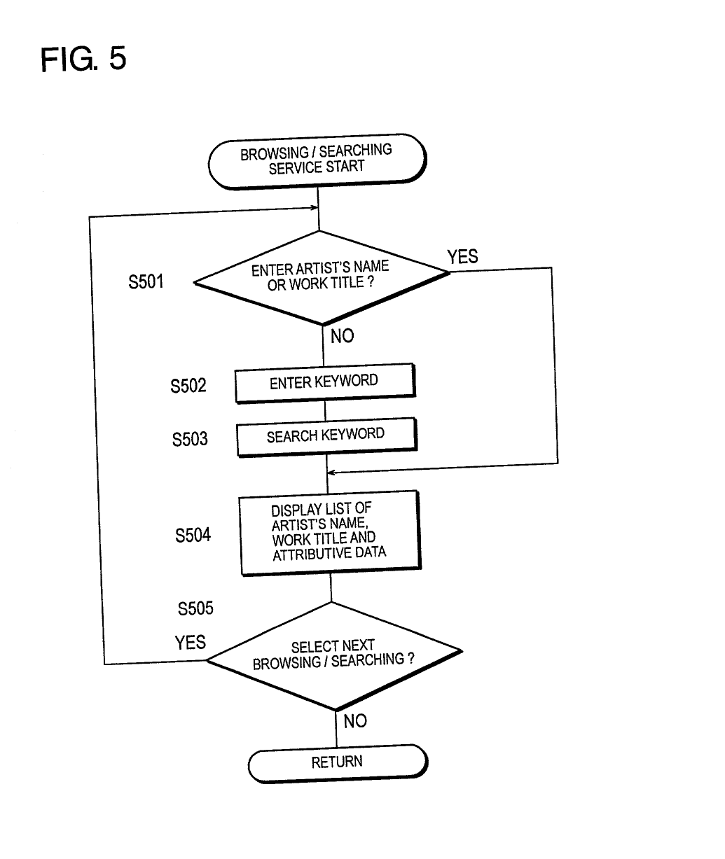

The “Browsing/Searching” menu provides browsing/searching services on entry artists' attributive data, entry works' titles, etc., for an accessing supporter at the browsing/searching site consisting of a server 37. FIG. 5 is a flow chart showing how browsing/searching services are provided by server 37 at a browsing/searching service site. At the browsing/searching service site, the system asks an accessing person to enter an artist name or work title (S501), conducts a keyword search upon receiving a keyword input (S502, S503), and displays the corresponding artist's name, work title, attributive data, etc., extracting them from the entry artist database consisting of the server 36 (S504).

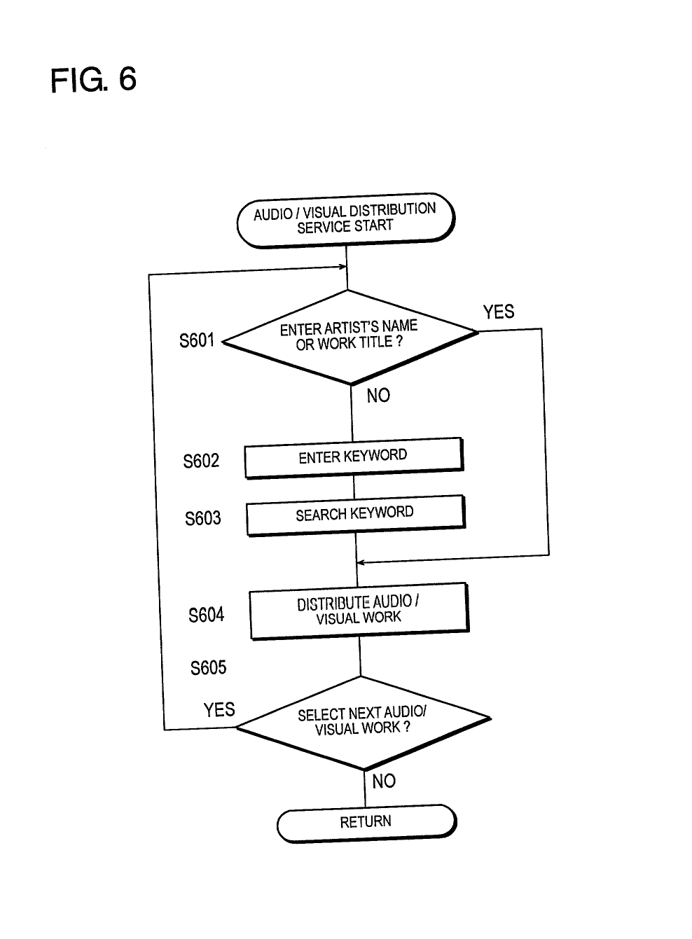

The “Audio/Visual” menu provides entry work audio/visual distributing services for an accessing supporter at the audio/visual distribution site consisting of the server 38. FIG. 6 is a flow chart showing how audio/visual distributing services are provided by server 38 at a audio/visual distribution site. At the audio/visual distribution site, the system asks an accessing person to enter an artist name or work title (S601), conducts a keyword search upon receiving a keyword input (S602, S603), and distributes the corresponding entry work, downloading it from the entry work database consisting of the server 35 (S604). In the audio/visual distributing service according to the present invention, the audio/visual distribution of a work does not necessarily have to be made online through a network such as the Internet, but can also be made by an appropriate offline method such as storing the work in an appropriate media such as a CD-ROM, DVD, cassette tape, video tape, or book and delivering it by postal service, courier service, etc., or providing the work directly through facsimile, telephone, concert, event, private showing, etc.

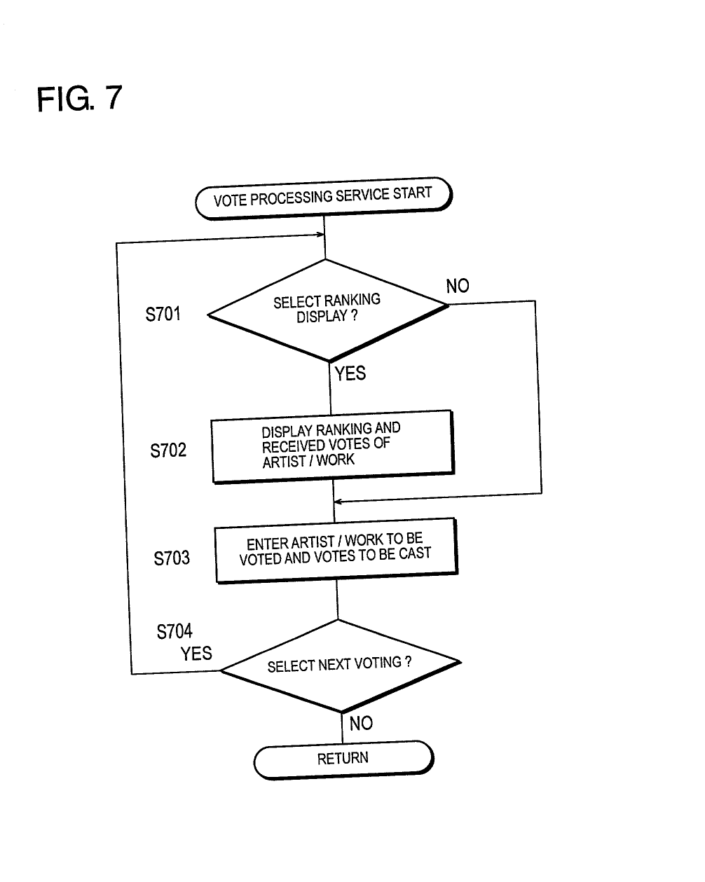

The “Voting” menu provides a service for accepting votes from an accessing supporter on registered artists or works that the supporter wish to support at the voting service site 39. FIG. 7 is a flow chart showing how voting services are provided by server 39 at a voting service site. The system allows a supporter to specify and cast votes for artists or works that the supporter wishes to support among the registered artists and works (S703). It is possible to arrange in this case in such a way that the system allows the accessing person to decide whether to display the ranking of the particular artist or work in the number of votes captured (S701), and displays the ranking if the accessing person choose to see the ranking (S702). In the artist supporting and mediating system of the present invention, the voting for a registered artist or work does not necessarily have to be made online through a network such as the Internet, but can also be made by an appropriate offline method such as postal service, courier service, facsimile, telephone, and face-to-face delivery.

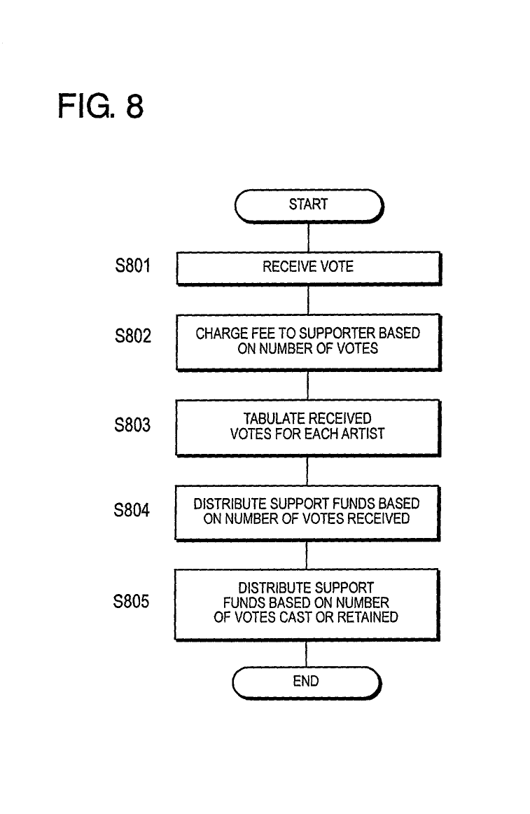

FIG. 8 is a flow chart showing the process of voting and various after services, which are characteristic portions of the artist supporting and mediating system according to the present invention. When votes by a supporter are received by a server 39, which is the vote accepting server (S801), the fee charging process for the supporter is executed according to the number of votes being cast based on the predetermined unit price per vote by the server 40, which is the fee collecting server (S802). The payment of the fees can be made either by means of a credit card information preregistered in the membership database, a prepaid point system, electronic money, or an offline process such as money transfer through a financial institution.

When the voting is concluded at the voting service site by the vote processing means, a server 41, which is the vote tabulating server, tabulates the number of votes for each registered artist and work (S803). A server 42, which is the support fund distributing server, executes the process of distributing the supporting fund to each artist according to the number of votes each artist received based on the predetermined rate (S804). When the amount of supporting fund for each artist is calculated by the supporting fund distributing means, the supporting fund is distributed to each artist to the credit card account of each artist based on the credit card information registered in the membership database. Simultaneously, based on said tabulation, a server 43, which is the dividend distributing server, executes the process of distributing the dividend to each supporter according to the number of votes cast or retained by each supporter based on the predetermined rate (S805). When the amount of dividend for each supporter is calculated by the dividend distributing means, the dividend is distributed to each artist to the credit card account of each supporter based on the credit card information registered in the membership database. The payment of said supporting fund or dividend can be made either by a prepaid point system, electronic money as mentioned in the fee charging method, or an offline process such as money transfer through a financial institution. The processing result obtained by said tabulating process means, as well as the ranking information, will be stored in the ranking database consisting of a server 44.

Tables 1 through 3 show examples of voting and tabulating processes as well as distribution processes of supporting funds and dividends. In these tables, A through H represent artists and the tables show the tabulation and processing results up to the third voting.

On the Table 1, the support fund S_{(x, n)} to the artist X on the n-th voting is calculated according to the formula (1) below:

S_{(x, n)}=α×β×γ_{(x, n)} (1)

where α is a unit price per vote and β is a support fund, distribution rate, which are predetermined by the organizer. Also, γ_{(x, n)} denotes the number of votes the artist X got on the n-th voting.

In case of Table 1, it is assumed that the unit price per vote α is 50 yen and the support fund distribution rate β is 50%, and that the artist got 2000 votes in the first voting, 3000 votes in the second voting, and 2000 votes in the third voting, so that the support fund S_{(A, n)} for the artist A is calculated as follows:

The first support fund S_{(A, 1)}=50 yen×0.5×2,000 votes=50,000 yen

The second support fund S_{(A, 2)}=50 yen×0.5×3,000 votes=75,000 yen

The third support fund S_{(A, 3)}=50 yen×0.5×2,000 votes=50,000 yen

On Table 1, the dividend per vote D_{(x, n)} concerning the artist X on the n-th voting is calculated according to the formula (2) below:

D_{(x, n)}=(α×δ×γ_{(x, n+1)})/γ_{(x, n)} (2)

where δ is a dividend distribution rate to each voter, which is predetermined by the organizer.

In case of Table 1, it is assumed that the dividend distribution rate δ is 50%, so that the dividend D_{(A, n)} per one vote for the artist A on each voting is calculated as follows:

The first dividend D_{(A, 1)}=(50 yen×0.5×3,000 votes)/2,000 votes=37.5 yen

The second dividend D_{(A, 2)}=(50 yen×0.5×2,000 votes)/3,000 votes=16.7 yen

Therefore, a supporter who voted for the artist A in the first voting is entitled to receive 37.5 yen per vote. Incidentally, although the organizer's operating cost is not included in the example shown in Table 1, it is possible to include the organizer's operating cost in the calculation.

In case of Table 2, the support fund S_{(x, n)} for the artist X is calculated according to the formula 1. The unit price per vote a is 50 yen and the support fund distribution rate β is 50%.

In case of Table 2, the dividend D_{(x, n)} per one vote for the artist X on the n-th voting is calculated as follows:

D_{(x, n)}=α×δ×ε_{(x, n)} (3)

where ε_{(x, n)} denotes the dividend index concerning the artist X on the n-th voting. ε_{(x, n)} is expressed as a function of the vote getting rate ζ_{(x, n)} of the artist X on the n-th voting, and its calculation method is predetermined by the organizer as follows:

ε_{(x, n)}=F (ζ_{(x, n)} ) (4)

ζ_{(x,n)}=γ_{(x, n)}/Σγ_{(i, n)} (5)

where Σγ_{(i, n)} is the total number of votes cast in the n-th voting.

In case of Table 2, the dividend distribution rate δis 50%. Incidentally, the dividend indices ε_{(A, n)} for the artist A for the first through third voting are calculated as 1.11, 1.16 and 1.00 respectively based on the vote getting rate ζ_{(A, n)} of 0.32, 0.24 and 0.16 (as the calculation method is arbitrarily decided, the explanation on how these values are derived is omitted here), so that the dividend per vote D_{(A, n)} concerning the artist A is calculated as follows:

The first dividend D_{(A, 1)}=50 yen×0.5×1.11=27.8 yen

The second dividend D_{(A, 2)}=50 yen×0.5×1.16=25.8 yen

The third dividend D_{(A, 3)}=50 yen×0.5×1.00=25.0 yen

Therefore, a supporter who voted for the artist A on the first voting will receive 27.8 yen for each vote. Incidentally, although the organizer's operating cost is not included in the example shown in Table 2, it is possible to include the organizer's operating cost in the calculation.

In the case of Table 3, the support money S_{(x, n)} for the artist X is calculated according to the formula (1). The unit price per vote α is 50 yen and the support fund distribution rate β is 100%. Incidentally, although the organizer's operating cost is not included in the example shown in Table 3, it is possible to include the organizer's operating cost in the calculation.

In the case of Table 3, if the artist X becomes successful and the revenue due to the artistic activities comes to match the condition agreed in advance between the organizer and the contractor, the dividend D for an arbitrary supporter of the artist X shall be calculated according to the formula (6) below:

D=η/Σγ_{(x, i)}×Σ(ε_{(x, i)}×θ_{(x, i)}) (6)

where η is the total dividend amount to be paid by the artist X according to said agreement, Σγ_{(x,i)} is the aggregate number of votes cast for the artist X up to the n-th voting,

ε_{(x, i)} is the dividend index concerning the artist X on the i-th voting, θ_{(x, i)} is the number of votes said supporter cast on the i-th voting, and Σ (ε_{(x, i)}×θ_{(x, i)} ) is the aggregate dividend indices concerning the artist X for said supporter up to the n-the voting.

In the case of Table 3, it is assumed that the artist A's revenue due to the artistic activities comes to match the condition agreed in advance between the organizer and the contractor after the third voting, and that the total dividend amount to be paid by the artist A according to said agreement is 1 million yen. If it is assumed that the aggregate number of votes Σ γ_{(A, 3)} cast up to the third voting is 20,000 votes and the votes for the artist A cast by a certain supporter Y are 1, 2 and 0 for the first, second and third voting respectively, the dividend D to be paid to the supporter Y is as follows:

Dividend D=1,000,000 yen/20,000×(1.20×1+2.10×2+1.42×0)=270 yen

TABLE 1

| | | | |
|---|---|---|---|
| | Received votes | Support fund | Dividend |
| Artist | γ (x, n) | S (x, n) | D (x, n) |

First vote

| | | | |
|---|---|---|---|
| A | 2,000 | 50,000 | 38 |
| B | 1,500 | 37,500 | 17 |
| C | 1,000 | 25,000 | 50 |
| D | 700 | 17,500 | 54 |
| E | 500 | 12,500 | 15 |
| F | 300 | 7,500 | 83 |
| G | 200 | 5,000 | 6 |
| H | 100 | 2,500 | 13 |
| Total | 6,300 | 157,500 | 35 |

Second vote

| | | | |
|---|---|---|---|
| A | 3,000 | 75,000 | 17 |
| B | 1,000 | 25,000 | 13 |
| C | 2,000 | 50,000 | 19 |
| D | 1,500 | 37,500 | 50 |
| E | 300 | 7,500 | 8 |
| F | 1,000 | 25,000 | 50 |
| G | 50 | 1,250 | 10 |
| H | 50 | 1,250 | 10 |
| Total | 8,900 | 222,500 | 26 |

Third vote

| | | |
|---|---|---|
| A | 2,000 | 50,000 |
| B | 500 | 12,500 |
| C | 1,500 | 37,500 |
| D | 3,000 | 75,000 |
| E | 100 | 2,500 |
| F | 2,000 | 50,000 |
| G | 20 | 500 |
| H | 20 | 500 |
| Total | 9,140 | 228,500 |

Unit price per vote (α) = 50 yen
Support fund distribution rate (β) = 50%
Dividend distribution rate (δ) = 50%

TABLE 2

| | | Vote | | | |
|---|---|---|---|---|---|
| | Received | getting | Support | Dividend | |
| | votes | rate | fund | index | Dividend |
| Artist | γ_{(X, n)} | ζ_{(X, n)} | S_{(X, n)} | ε_{(X,n)} | D_{(X, n)} |
| | First vote | | | | |
| A | 2,000 | 0.32 | 50,000 | 1.11 | 27.8 |
| B | 1,500 | 0.24 | 37,500 | 1.03 | 25.8 |
| C | 1,000 | 0.16 | 25,000 | 0.95 | 23.8 |
| D | 700 | 0.11 | 17,500 | 0.91 | 22.7 |
| E | 500 | 0.08 | 12,500 | 0.87 | 21.9 |
| F | 300 | 0.05 | 7,500 | 0.84 | 21.1 |
| G | 200 | 0.03 | 5,000 | 0.83 | 20.7 |
| H | 100 | 0.02 | 2,500 | 0.81 | 20.3 |
| Total | 6,300 | 1.00 | 157,500 | | |
| | Second vote | | | | |
| A | 6,000 | 0.39 | 150,000 | 1.16 | 29.1 |
| B | 1,000 | 0.07 | 25,000 | 0.84 | 20.9 |
| C | 2,000 | 0.13 | 50,000 | 0.90 | 22.5 |
| D | 1,500 | 0.10 | 37,500 | 0.87 | 21.7 |
| E | 300 | 0.02 | 7,500 | 0.79 | 19.8 |
| F | 3,000 | 0.20 | 75,000 | 0.97 | 24.2 |
| G | 500 | 0.03 | 12,500 | 0.80 | 20.1 |
| H | 1,000 | 0.07 | 25,000 | 0.84 | 20.9 |
| Total | 15,300 | 1.00 | 382,500 | | |
| | Third vote | | | | |
| A | 2,000 | 0.20 | 50,000 | 1.00 | 25.0 |
| B | 500 | 0.05 | 12,500 | 0.85 | 21.2 |
| C | 1,500 | 0.15 | 37,500 | 0.95 | 23.7 |
| D | 3,000 | 0.30 | 75,000 | 1.10 | 27.5 |
| E | 100 | 0.01 | 2,500 | 0.80 | 20.2 |
| F | 500 | 0.05 | 12,500 | 0.85 | 21.2 |
| G | 2,000 | 0.20 | 50,000 | 1.00 | 25.0 |
| H | 250 | 0.03 | 6,250 | 0.82 | 20.5 |
| Total | 9,850 | 1.00 | 246,250 | | |

Unit price per vote (α) = 50 yen
Support fund distribution rate (β) = 50%
Dividend distribution rate (δ) = 50%

TABLE 3

| | Aggregate | | | | |
|---|---|---|---|---|---|
| | number | | Vote | | |
| | of votes | Received | getting | Support | Dividend |
| | received | votes | rate | fund | index |
| Artist | Σγ_{(X, i)} | γ_{(X, n)} | ζ_{(X, n)} | S_{(X, n)} | ε_{(X, n)} |
| | First vote | | | | |
| A | 2,000 | 2,000 | 0.32 | 100,000 | 1.20 |
| B | 1,500 | 1,500 | 0.24 | 75,000 | 1.12 |
| C | 1,000 | 1,000 | 0.16 | 50,000 | 1.04 |
| D | 700 | 700 | 0.11 | 35,000 | 0.98 |
| E | 500 | 500 | 0.08 | 25,000 | 0.96 |
| F | 300 | 300 | 0.05 | 15,000 | 0.92 |
| G | 200 | 200 | 0.03 | 10,000 | 0.90 |
| H | 100 | 100 | 0.02 | 5,000 | 0.90 |
| Total | 6,300 | 6,300 | 1.00 | 315,000 | |
| | Second vote | | | | |
| A | 8,000 | 6,000 | 0.39 | 300,000 | 2.10 |
| B | 2,500 | 1,000 | 0.07 | 50,000 | 0.82 |
| C | 3,000 | 2,000 | 0.13 | 100,000 | 1.38 |
| D | 2,200 | 1,500 | 0.10 | 75,000 | 1.32 |
| E | 800 | 300 | 0.02 | 15,000 | 0.62 |
| F | 3,300 | 3,000 | 0.20 | 150,000 | 1.74 |
| G | 700 | 500 | 0.03 | 25,000 | 1.22 |
| H | 1,100 | 1,000 | 0.07 | 50,000 | 1.56 |
| Total | 21,600 | 15,300 | 1.00 | 765,000 | |
| | Third vote | | | | |
| A | 10,000 | 2,000 | 0.20 | 100,000 | 1.42 |
| B | 3,000 | 500 | 0.05 | 25,000 | 0.36 |
| C | 4,500 | 1,500 | 0.15 | 75,000 | 1.42 |
| D | 5,200 | 3,000 | 0.30 | 150,000 | 2.52 |
| E | 900 | 100 | 0.01 | 5,000 | 0.14 |
| F | 3,800 | 500 | 0.05 | 25,000 | 0.56 |
| G | 2,700 | 2,000 | 0.20 | 100,000 | 2.78 |
| H | 1,350 | 250 | 0.03 | 12,500 | 0.72 |
| Total | 31,450 | 9,850 | 1.00 | 492,500 | |

Unit price per vote (α) = 50 yen
Support fund distribution rate (β) = 100%

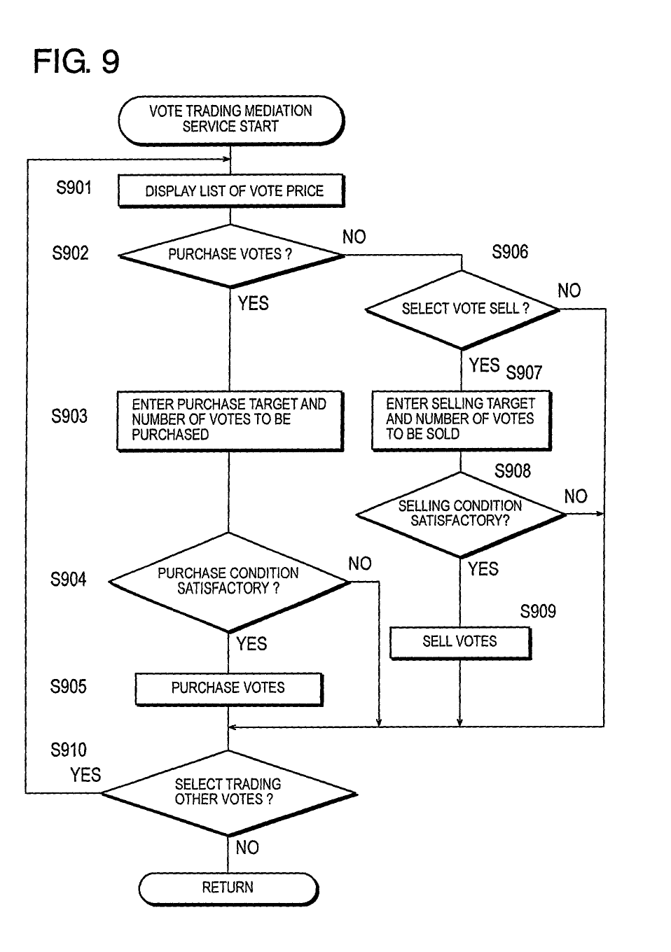

The “Vote Trading” menu provides at the server 45 a service for trading the votes owned by supporters among multiple accessing supporters votes. FIG. 9 is a flow chart showing how vote trading mediation services are provided by server 45 at a vote trading mediation site. At the vote trading mediation site, the system displays the vote price of each registered artist at the time of each voting (S901), and asks the accessing person to choose between buying or selling votes (S902, S906). When the accessing person chooses to buy votes, the system asks the accessing person to enter the target of the purchase and the number of votes to be purchased (S903), determines whether the purchase condition is met checking the accessing person's credit information, etc., from the membership database, executes the purchase if the condition is met, and register the result to the membership database (S905). If the accessing party chooses to sell votes, the system asks the accessing person to enter the target of the sale and the number of votes to be sold (S907), determines whether the sale condition is met checking the accessing person's vote holding information, etc., from the membership database, executes the sale if the condition is met, and register the result to the membership database (S909). In the artist support and mediating service according to the present invention, the vote trading does not necessarily have to be made online through a network such as the Internet, but can also be made by an appropiate offline method such as postal service, courier service, facsimile, telephone, and face-to-face delivery.

As the artist support and mediating service according to the present invention is constituted in such a way as described above, it provides the following effects.

The artist support and mediating service according to the present invention can publicize the works and other creative activities of unknown artists to general listeners, viewers and others who appreciate creative works, provide unknown artists the place to present their works and other creative activities, enable them to promote and appeal themselves and their works to the public, giving them chances to succeed, provide viewers, listeners and other opportunities to be exposed to unknown artists, their works and activities, and thus provide them the chance to find unknown talented artists and help those artists to grow.

The artist support and mediating service according to the present invention provides opportunities for listeners, viewers and others who appreciate creative works by financially supporting unknown artists whom they favor and also provides environments for those artists to sustain creative activities with the help of those financial supports so that they can grow without the help of major sponsors until those artists become capable of sustaining their activities on their own income.

Moreover, listeners, viewers and art lovers who assist those artists wish to have a certain mechanism through which they can expect some dividends for the investment they made up to the point when those artists they have assisted succeed professionally, despite the fact that their financial supports to the artists are autonomous acts.

It is obvious that this invention is not limited to the particular embodiments shown and described above but may be variously changed and modified without departing from the technical concept of this invention. Further, the entire disclosure of Japanese Patent Application No. 2000-176022 filed on Jun. 12, 2000, including the specification, claims, drawings and summary are incorporated herein by reference in its entirety.

What is claimed is:

1. Artist supporting and mediating system comprising:
a vote accepting computer that accepts votes from supporters of preregistered artists or their artistic works;
a fee collecting computer that handles a process of charging fees to said supporters according to numbers of votes cast and a predetermined unit fee per vote;
a vote tabulating computer that tabulates votes for each artists or artistic work; and
a support fund distributing computer that distributes support funds to said artist or an artist who produced said artistic work corresponding to said number of votes based on a predetermined rate.

2. The artist supporting and mediating system described in claim 1 further comprising a dividend distributing computer that distributes dividends to each supporter according to the number of votes cast by said supporter or the number of votes owned by said supporter based on a predetermined condition.

3. The artist supporting and mediating system described in claim 2 wherein said dividend distributing computer distributes dividends when profits generated by artistic activities of said artist match with a predetermined condition.

4. The artist supporting and mediating system described in claims 1 further comprising a vote trade mediating computer that mediates trades of votes owned by said supporters.

5. The artist supporting and mediating system described in claims 1 further comprising a audio/visual distributing service computer that provides a service of audio/visual distribution of artistic works of preregistered artists to said supporters.

6. The artist supporting and mediating system described in claims 1 further comprising a browsing/searching service computer that provides a service of allowing said supporters to browsing and/or searching attributive data of preregistered artists.

7. The artist supporting and mediating system described in either one of claims 1 through 6 comprising supporters' terminals and each said computers, which are interconnected via a computer network.

8. The artist supporting and mediating system described in either one of claims 1 through 6 comprising artists' terminals and each said computers, which are interconnected via a computer network.
